(19) United States
(12) Patent Application Publication
(10) Pub. No.: US 2010/0037780 A1
(43) Pub. Date: Feb. 18, 2010

(54) LID, IN PARTICULAR FOR A DISPOSABLE CUP

(75) Inventors: David Wilfried Magda Pas, Antwerp (BE); Frederik Wouters, Rupelmonde (BE)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., d/b/a UNILEVER, Englewood Cliffs, NJ (US)

(21) Appl. No.: 12/541,255

(22) Filed: Aug. 14, 2009

(30) Foreign Application Priority Data
Aug. 18, 2008 (EP) EP08162497

(51) Int. Cl. A47J 31/00; B65D 51/00; A47G 19/22

(52) U.S. Cl. 99/290; 220/200; 220/713

(57) ABSTRACT

Disclosed is a lid (100), in particular for a disposable cup. The lid comprises an infusion chamber (110) having at least one water-permeable wall (111) and comprising an infusible substance; a flange (120) for attaching the lid to the rim (210) of a cup (200); and a body section (130) comprising a moveable portion (135). The infusion chamber (110) is attached to the moveable portion (135) and with the lid (100) fitted to the cup (200), the moveable portion (135) is reversibly translatable between a raised and a lowered position in a direction (A) substantially perpendicular to the plane of the rim (210).

### TECHNICAL FIELD OF THE INVENTION

The present invention relates to lids for cups, especially disposable cups, in which infused liquid beverages are dispensed. In particular, the present invention relates to such lids which allow for the safe and convenient preparation of infusion beverages and avoid the need to remove and dispose of an infusion bag before consuming the beverage.

### BACKGROUND OF THE INVENTION

Many liquid beverages are made by infusion. These include tea beverages which may be made by infusing green, black, white or oolong teas derived from the plant Camellia sinensis or by infusing other plant materials to give the so-called herbal teas and coffee beverages which are made by infusing roasted and ground coffee beans or by infusing processed coffee products such as instant coffee powders or granules. The preferred liquid beverages are tea beverages.

Liquid beverages such as those sold to the consumer in an out-of-home environment (e.g. fast food or take-away establishments or catering situations such as canteens in the workplace) are often served in a container which has a lid to minimise spillage. The lid may be provided with a drinking aperture through which the consumer drinks the beverage. Such beverages are often prepared by immersing an infusion bag (such as a tea bag) in water in the container and allowing the contents of the infusion bag to infuse for sufficient time to achieve the strength of beverage required by the consumer.

To enhance the infusion many consumers agitate the infusion bag in the water. If the infusion bag is provided with a string and tag, the user may use the string to move the infusion bag up and down through the water in the container. After a sufficient infusion time the user must remove the infusion bag from contact with the water to prevent further infusion. This can be a messy operation as the infusion bag when removed from the water still has water contained in it which can drip as the infusion bag is moved. The above-described agitation and removal of the infusion bag is made much more difficult if the container is provided with a lid which must be removed before the agitation and bag removal can take place. Removing the lid, and optionally replacing it before the beverage is consumed increases the risk that the beverage will be spilled. As the beverage may be hot this increases the chance of the consumer being hurt by the hot liquid and of the liquid being spilled onto the consumer's clothing or into the surroundings.

WO 2004/026722 (Unilever) discloses containers which have a lid wherein the lid is provided with an opening having a first portion which is capable of gripping the string of an infusion bag and a second portion through which the string of the infusion bag can move into and out of the container. This arrangement allows for the consumer to move the infusion bag within the container by pulling the string through the second portion of the opening and then to lock the infusion bag in a raised position, thus stopping the infusion process, by gripping the string in first portion of the opening.

Whilst the lids and containers disclosed in WO 2004/026722 ensure that the consumer can be supplied with an infused liquid beverage in a safe and convenient manner and avoid the need to remove and dispose of the infusion bag before consuming the beverage, they have certain drawbacks. From a manufacturing point of view, threading of the string and tag through the opening in the lid is difficult to automate. From a user's point of view, locking the infusion bag in a raised position does not always guarantee that the infusion process will be completely stopped or that the infusion bag will not interfere with the drinking process. For example, depending on how high the bag is raised and/or how the beverage moves within the container during drinking, the bag may re-contact the beverage and/or obstruct the drinking aperture. Furthermore, the length of string which is drawn outside of the cup may swing loosely and/or touch the face of a user during drinking.

DE 20 2005 012 125 U1 (Horst Mahler) discloses a disposable drinking cup, comprising perforated a container for accommodation of tea leaves attached to lid. However, the lids disclosed in DE 20 2005 012 125 U1 are inconvenient because in order to stop the brewing process, the lid must be removed from the container.

Thus we have developed a means to allow for supply to a consumer of an infused liquid beverage in a safe and convenient manner whilst avoiding the need to remove and dispose of an infusion bag before consuming the beverage, but without one or all of the above mentioned drawbacks.

### SUMMARY OF THE INVENTION

In a first aspect, the present invention provides a lid, in particular for a disposable cup, the lid comprising:
(a) an infusion chamber having at least one water-permeable wall and comprising an infusible substance;
(b) a flange for attaching the lid to the rim of a cup; and
(c) a body section comprising a moveable portion;
   wherein the infusion chamber is attached to the moveable portion and wherein, with the lid fitted to the cup, the moveable portion is reversibly translatable between a raised and a lowered position in a direction (A) substantially perpendicular to the plane of the rim.

In further aspects, the invention relates to a container comprising the lid attached to a cup and a method of making a beverage with the container.

The use of an infusion chamber attached to the moveable portion dispenses with the need for a separate infusion bag with a string. Furthermore, providing that the moveable portion is reversibly translatable between a raised and a lowered position allows the infusion chamber to be lowered to contact the liquid in the cup to brew the infusible substance and then raised in order to take the water-permeable wall out of contact with the liquid in the cup and thereby stop the infusion process. Translational movement is especially convenient as the depth to which the infusion chamber may be lowered into the cup is not restricted by the diameter of the lid and/or cup.

It is especially preferred that the moveable portion comprises a collapsible structure as the effect of the lid on the overall height of the container can then be minimised which may be important when considering the stability of the container against toppling over. Preferably the collapsible structure may comprise one or more pleats. More preferably the pleat or pleats unfold when the moveable portion is translated away from the rim and into the cup. Alternatively or additionally, the moveable portion may comprise a telescopic structure.

The infusion chamber may be integrally moulded with the movable portion or may be a separate piece attachable thereto. It is especially preferred that the moveable portion is not integrally moulded with the moveable portion as this allows, for example, for a plurality of series of chambers to manufactured separately from the remainder of the lid, each series with a different infusible material therein. A consumer may then choose a chamber comprising an infusible substance according to his taste and then assemble the lid directly before infusion. A further advantage of not having the chamber integrally moulded with the moveable portion, is that the remainder of the lid is likely to be easier to store as it may be, for example, stackable. Preferably the infusion chamber comprises a protrusion and the protrusion is engageable by an aperture on the moveable portion as this allows for easy assembly of the lid. However, in order that the effect of the lid on the overall height of the container can then be minimised it is preferred that the protrusion is not longer than the remainder of the chamber, or in other words that the height of the protrusion is not more than 50% of the total height of the chamber. The protrusion may conveniently form a knob or handle by which a user may translate the moveable portion. Additionally or alternatively, the protrusion may have disposed thereon indicia of the type of infusible material, the flavour of the infusible material and/or the brand of the infusible material. A convenient arrangement to ensure that the chamber does not easily detach from the movable portion is wherein the protrusion comprises a barb.

In order to avoid the consumer having to manipulate the wet infusion chamber after infusion, it is preferred that the lid additionally comprises a drinking aperture. The consumer may then brew and drink the beverage without having to remove the lid. To minimise interference of the infusion chamber with the drinking process it is preferred that the chamber is located away from the centre of the lid in a first radial direction and the drinking aperture is located away from the centre of the lid in a radial direction substantially opposite to the first radial direction.

### BRIEF DESCRIPTION OF THE DRAWINGS

The present invention will now be further described by reference to the drawings in which:

FIG. 1 is sectional perspective view of a lid in accordance with the present invention.

FIG. 2 is a perspective view of a container comprising the lid of FIG. 1.

FIG. 3 is a perspective view of the container of FIG. 2, partly in section, with the movable portion in a raised position.

FIG. 4 is a perspective view of the container of FIG. 2, partly in section, with the movable portion in a lowered position.

### DETAILED DESCRIPTION

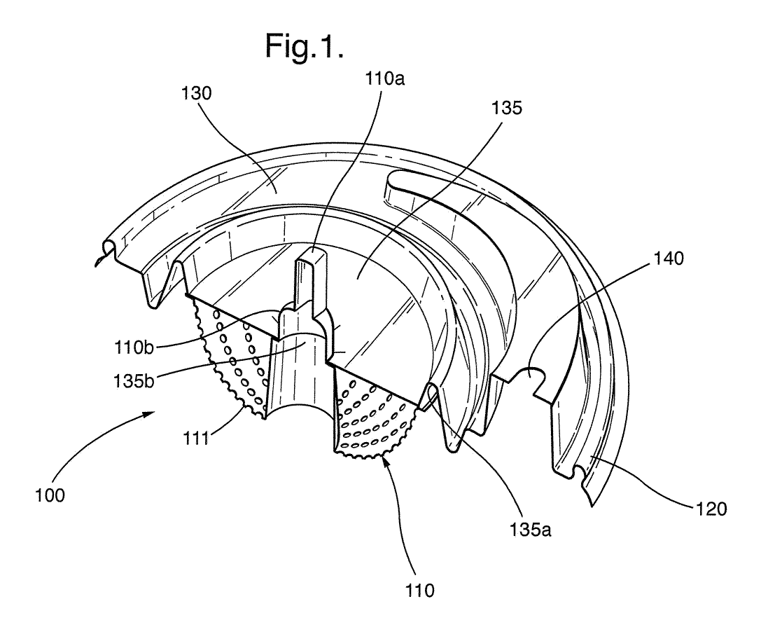

The present invention will now be further described by reference to the following preferred embodiment illustrated in FIGS. 1 to 4.

A lid (100) comprises a flange (120) encircling a body section (130) and integrally moulded therewith. The flange (120) is attachable to the rim (210) of a disposable cup (200), preferably forming a liquid-tight seal therewith. The body section (130) comprises a moveable portion (135) which has a series of concentric pleats (135a) and surrounds an aperture (135b). The body section also comprises a raised spout having a drinking aperture (140). The aperture (135b) of the moveable portion (135) is located away from the centre of the lid (100) in a first radial direction and the drinking aperture (140) is located away from the centre of the lid (100) in the radial direction opposite to the first radial direction.

An infusion chamber (110) has a roughly hemispherical wall (111) which is water-permeable and surrounds an infusible material (not shown), such as tea leaves. The wall (111) may comprise a rigid material having perforations as shown. Additionally or alternatively the wall (111) may comprise a filter material such as is commonly used in tea bag manufacture, such as non-woven fabric or nylon mesh. Extending vertically upwards from the centre of the wall (111) is a hollow protrusion (110a) having a barb (110b). The protrusion (110a) is engaged by the aperture (135b) on the moveable portion (135) and is held therein owing to presence of the barb (110b). Thus the infusion chamber (110) is secured to the underside of the moveable portion (135).

In use, a consumer selects a chamber (110) containing the desired infusion material, for example green tea. The infusion material is identified by the words “Lipton® Green Tea” printed on the protrusion (110a). The consumer then locates the protrusion (110a) within the aperture (135b) on the movable portion (135) of the lid (100) and pushes the protrusion (110a) therethrough until the barb (110b) snaps through on the top of the moveable portion (135).

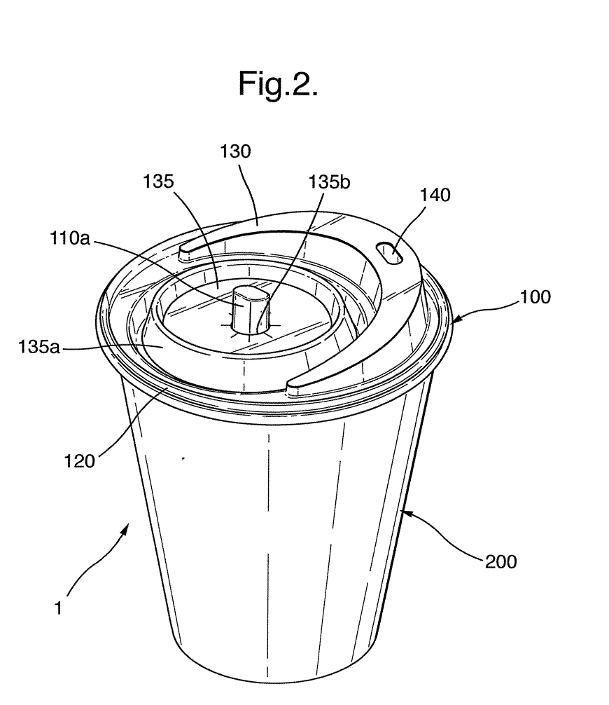

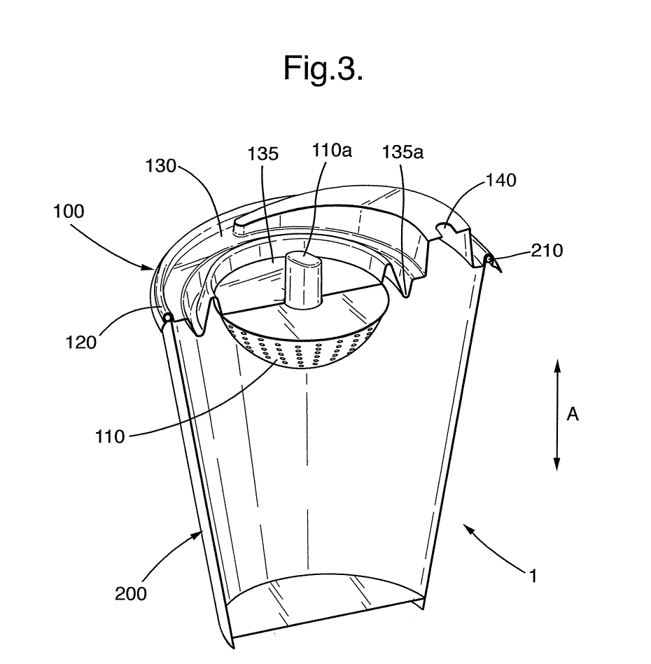

A liquid (not shown), for example, boiling water is then placed into the cup (200) until the cup (200) is, for example, about 80% full (with respect to the brimful capacity). The lid (100) is then attached to the rim (210) of the cup by means of the flange (120). The container now has the configuration shown in FIGS. 2 and 3.

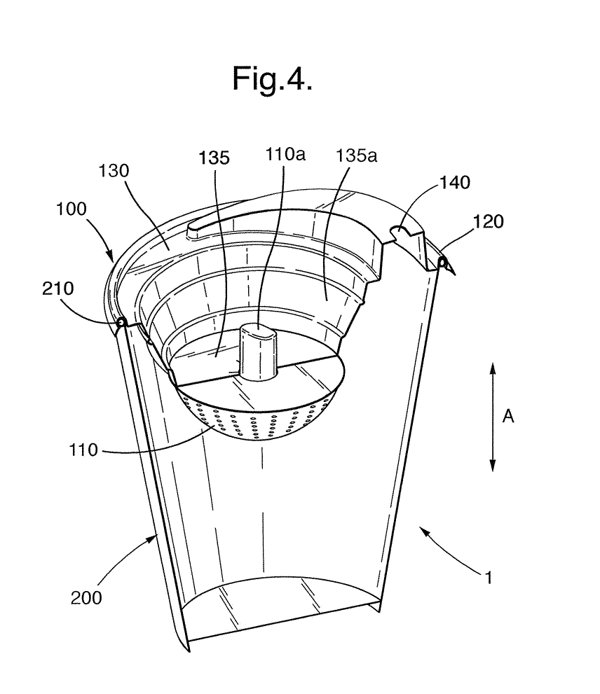

The consumer now initiates the brewing process by gripping the protrusion (110a) and pushing down thereon. As a result, the pleats (135a) unfold and the moveable portion (135) and the chamber (110) attached thereto are translated downwards in the direction (A) to contact the water-permeable wall (111) with the liquid in the cup. The pleats (135a) are shaped such that after a predetermined degree of downwards movement, the moveable portion (135) rests in the lowered position shown in FIG. 4. The consumer can thus stop pushing on the protrusion (110a) and does not need to hold the container whilst the tea is brewing.

When the desired infusion strength is attained, the consumer again grips the protrusion (110a) and this time pulls upwards thereon. As a result, the pleats (135a) re-fold and the moveable portion (135) and the chamber (110) attached thereto are translated upwards in the direction (A) to take the water-permeable wall (111) out of contact with the liquid in the cup (200) and thereby stop the infusion process. The pleats (135a) are shaped such that after a predetermined degree of upwards movement, the moveable portion (135) rests in the raised position shown in FIG. 3.

The consumer may now drink the infusion beverage (for example green tea) from the drinking aperture (140) without having to manipulate an infusion bag, without being obstructed by a swinging infusion bag and/or string, and with the knowledge that the strength of the beverage will not change on drinking as the brewing process has been effectively stopped.

1. A lid (100), in particular for a disposable cup, the lid comprising:
(a) an infusion chamber (110) having at least one water-permeable wall (111) and comprising an infusible substance;
(b) a flange (120) for attaching the lid to the rim (210) of a cup (200); and
(c) a body section (130) comprising a moveable portion (135);
wherein the infusion chamber (110) is attached to the moveable portion (135) and wherein, with the lid (100) fitted to the cup (200), the moveable portion (135) is reversibly translatable between a raised and a lowered position in a direction (A) substantially perpendicular to the plane of the rim (210).

2. A lid according to claim 1 wherein the moveable portion (135) comprises a collapsible structure.

3. A lid according to claim 2 wherein the collapsible structure comprises one or more pleats (135a).

4. A lid according to claim 3 wherein the pleat or pleats (135a) unfold when the portion (135) is translated away from the rim (210) and into the cup (200).

5. A lid according to claim 1 wherein the moveable portion (135) comprises a telescopic structure.

6. A lid according to claim 1 wherein the infusion chamber (110) is not integrally moulded with the moveable portion (135).

7. A lid according to claim 6 wherein the infusion chamber (110) comprises a protrusion (110a) and the protrusion is engageable by an aperture (135b) on the moveable portion (135).

8. A lid according to claim 7 wherein the protrusion (110a) is not longer than the remainder of the chamber (110).

9. A lid according to claim 7 wherein the protrusion (110a) comprises a barb (110b) which prevents the infusion chamber (110) from detaching from the moveable portion (135) once the protrusion (110a) is engaged.

10. A lid according to claim 1 wherein the lid additionally comprises a drinking aperture (140).

11. A container (1) comprising a cup (200) and a lid (100) according to claim 1, wherein the lid (100) is attached to the cup (200) by means of the flange (12).

12. A method of making a beverage comprising the steps of:
(i) providing a lid according to claim 1;
(ii) providing a cup;
(iii) adding a liquid to the cup;
(iv) fixing the lid to the cup by means of the flange;
(v) translating the moveable portion from the raised to the lowered position in order to contact the water-permeable wall with the liquid in the cup;
(vi) allowing the infusible substance to infuse in the liquid; and
(vii) when the desired infusion strength is attained, translating the moveable portion to the raised position in order to take the water-permeable wall out of contact with the liquid in the cup and thereby stop the infusion process.
